(19) United States
(12) Patent Application Publication
(10) Pub. No.: US 2014/0175987 A1
(43) Pub. Date: Jun. 26, 2014

(54) COLOR TEMPERATURE ADJUSTING METHOD AND ILLUMINATING DEVICE USING THE METHOD

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 14/056,967

(22) Filed: Oct. 18, 2013

(30) Foreign Application Priority Data
Dec. 24, 2012 (TW) 101149421

(51) Int. Cl. H05B 37/02

(52) U.S. Cl. CPC H05B 37/02
USPC 315/151; 315/297

(57) ABSTRACT

A color temperature adjusting method includes steps: providing a controller storing a color temperature setting value therein, a main white light source including first and second sub-main white light sources having different color temperatures, and an adjusting light source comprising red, green and blue light sources; comparing the color temperature setting value with that of an environmental light to obtain a difference value; controlling currents to the two sub-main white light sources, the red light source, the green light source and the blue light source to obtain a compensation light according to the difference value; and mixing the compensation light and the environmental light to obtain a resulted light which has a color temperature equal to the setting value. An illuminating device using the color temperature adjusting method is also provided.

### BACKGROUND

1. Technical Field

The present disclosure relates to a color temperature adjusting method of an illuminating device and an illuminating device using the method, and more particularly, to a color temperature adjusting method of an illuminating device whereby light generated by the illuminating device can have a high CRI (color rendering index).

2. Description of the Related Art

Illuminating device plays an important role in our daily life. Illuminating devices of different color temperatures are required in different situations or in different circumstances. LEDs (Light Emitting Diodes) have many advantages, such as high luminosity, low operational voltage, low power consumption, compatibility with integrated circuits, easy driving, long term reliability, and environmental friendliness. Such advantages have promoted the wide use of the LED lamps as a light source.

A typical white LED usually uses a blue light LED chip to excite yellow phosphors to thereby obtain white light which is a mixture of blue light and yellow light. FIG. 1 shows a CIE 1931 (International Commission on Illumination) color coordinates chart. In the color coordinates chart, the curve P is the Planck's curve, and the dotted points on the Planck's curve represents certain color temperatures of white light. Line Y in FIG. 1 represents a color distribution of the typical white LED by changing a concentration of the yellow phosphor. The Line Y and the Planck's curve P intersect at 4600K point. That is to say, the white LED with the single yellow phosphor can produce the real white light at the color temperature of 4600K only when the single yellow phosphor has a specific concentration. To change the concentration of the single yellow phosphor from the specific concentration, the color temperature can be varied; however, the color of the light also departs from the real white color. Such white LED with real white light at only one color temperature cannot satisfy various color temperature needs. To change the color temperature of the white light of the conventional white LED, different methods are proposed. However, such methods each obtain white light with an adjusted temperature having a low color rendering index which cannot reflect a real color of an illuminated object.

Therefore, it is desirable to provide a color temperature adjusting method of an illuminating device and an illuminating device using the method which can overcome the described limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 shows a chromaticity line of light generated by a conventional white LED by changing a concentration of a single phosphor of the white LED and a Planck's curve on a CIE 1931 chromaticity coordinates chart.

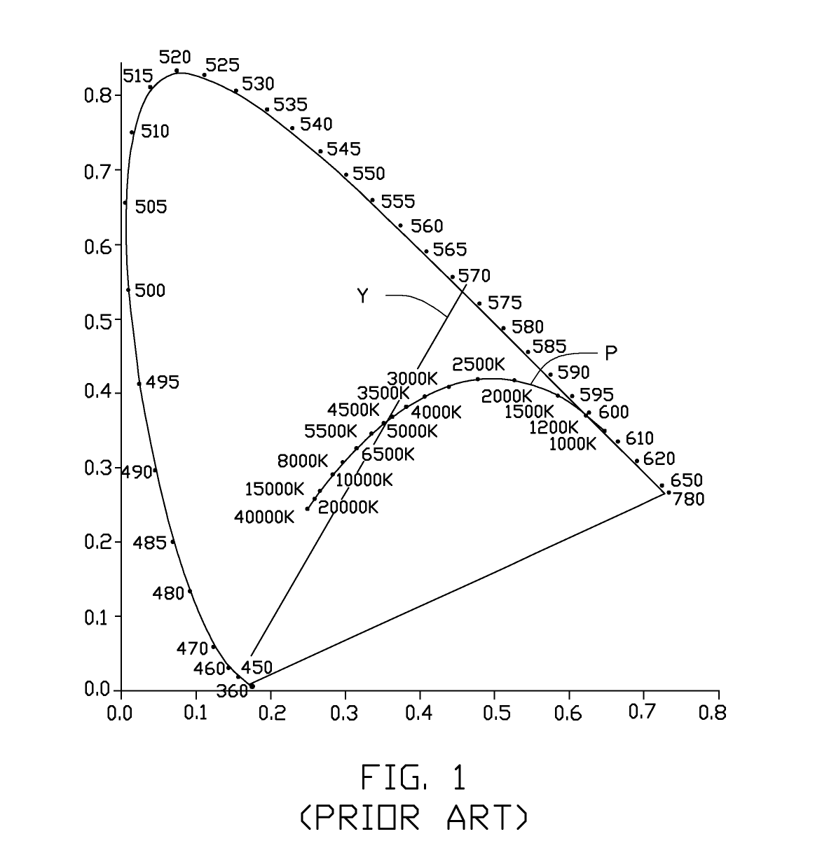

FIG. 2 shows the CIE 1931 chromaticity coordinates chart on which the chromaticity line Y of the conventional white LED is shown and light of an LED whose chromaticity is located on the chromaticity line Y is adjusted by a color temperature adjusting method in accordance with one embodiment of the present disclosure to obtain white light whose color temperature is different from that of the conventional white LED.

FIG. 3 is a schematic view of an illuminating device using the method shown in FIG. 2, wherein the illuminating device has white LEDs of different color temperatures surrounded by a plurality of red LEDs, green LEDs and blue LEDs.

FIG. 4 is a block diagram of the illuminating device using the method shown in FIG. 2.

### DETAILED DESCRIPTION

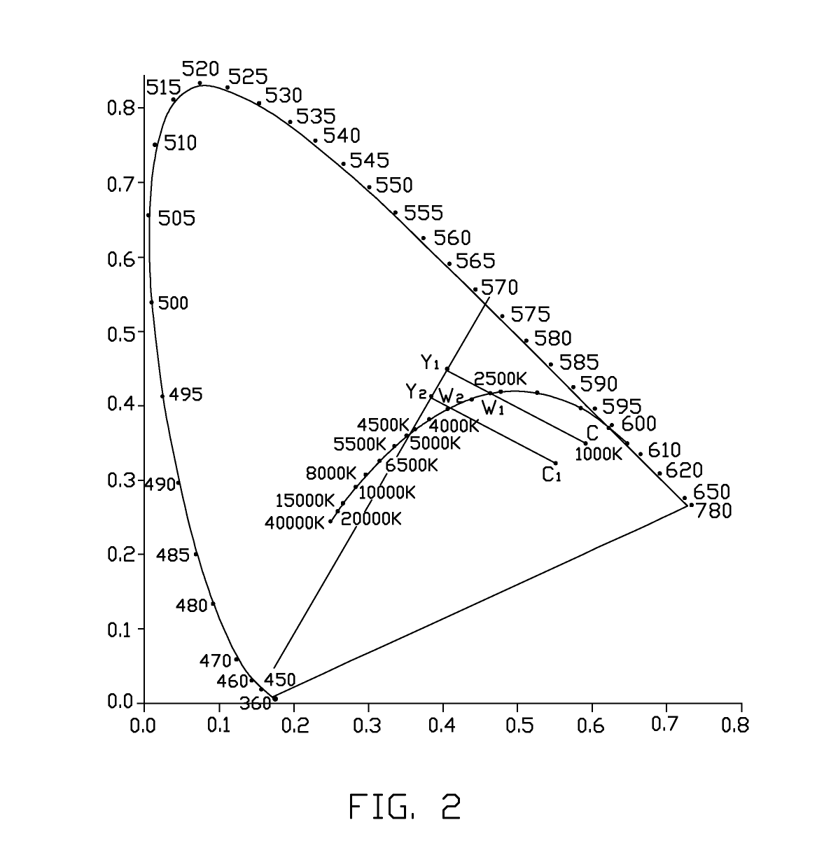

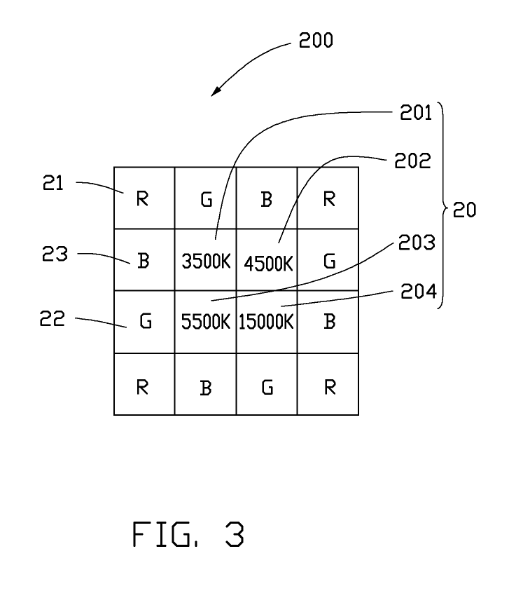

Referring to FIG. 3, a color temperature adjusting method of an illuminating device in accordance with one exemplary embodiment is provided. The method uses at least two sub-main white light sources, a red light source, a blue light source and a green light source. In this embodiment, four sub-main white light sources with different color temperatures are provided, wherein the color temperatures of the sub-main white light sources are 3500K, 4500K, 5500K, and 15000K, respectively. Brightness of each of the four sub-main white light sources can be adjusted by changing input current thereof. Specifically, I₁ is defined as an input current of the sub-main white source with 3500K color temperature, I₂ is defined as an input current of the sub-main white source with 4500K color temperature, I₃ is defined as an input current of the sub-main white source with 5500K color temperature, and I₄ is defined as an input current of the sub-main white source with 15000K color temperature. The brightness of the four sub-main white light sources are changed by adjusting ratios of the input current I₁, I₂, I₃, I₄ and thereby to adjust the color temperature of mixed main white light. The color temperature of the mixed main white light is close to that of the sub-main white light has a greater input current ratio. For example, when I₁:I₂:I₃:I₄ is equal to 1:1:0.25:0, the color temperature of the mixed main white light is close to 4100K to form a first main white light Y₁ (FIG. 2).

Referring to FIG. 2, the chromaticity of the main white light Yᵢ is located on the chromaticity line Y in the CIE 1931 chromaticity coordinates chart, and deviates from the Planck's curve P. The currents into the red light source, the green light source and the blue light source are adjusted to form a first adjusting light C. The first adjusting light C has a coordinate (0.62, 0.34) in the CIE 1931 chromaticity coordinates chart. The first adjusting light C and the first main white light Y₁ are mixed to form a first outgoing light W₁. That is the first adjusting light C drives the first main white light Y₁ to move to the Planck's curve P and thereby to get the outgoing light W₁ of 2800K color temperature. Since the first adjusting light C is formed by mixing the red light source, the green light source and the blue light source, the first adjusting light C has a good chromaticity and accordingly the first outgoing light W₁ has a good chromaticity.

Alternatively, when I₁:I₂:I₃:I₄ is equal to 1:1:1:0.365, the color temperature of the mixed main white light is close to 4700K to form a second main white light Y₂. The current into the red light source, the current into green light source and the current into the blue light source are adjusted to form a second adjusting light C₁. The second main white light Y₂ and the second adjusting light C₁ are mixed to form a second outgoing light W₂ having a good chromaticity located on the Planck's curve P.

In a word, in the color temperature adjusting method of the present disclosure, currents into a plurality of sub-main white light sources with different color temperatures are adjusted to change brightness thereof, and the sub-main white light sources are combined to form a mixed main white light source. The current into each of the red light source, the blue light source and the green light source is adjusted, and the red light source, the blue light source and the green light source are mixed to form an adjusting light, the adjusting light and the main white light from the mixed main white light source are mixed to form a finally outgoing light having a good color temperature and a good chromaticity. The number of the sub-main white light sources is not limited to four. It can be understood by a person skilled in the art that the more the number of the sub-main white light sources with different color temperatures has, the better chromaticity on the Planck's curve P the outgoing light has.

A controller is applied to connect with the sub-main white light sources, the red light source, the blue light source and the green light source. Specifically, a color temperature setting value is stored in the controller before forming the first and second main white light Y₁, Y₂; the color temperature setting value is compared with environmental light to obtain a difference value; then each of the currents into the sub-main white light sources, the red light source, the blue light source and the green light source is adjusted according to the difference value to form the outgoing light; finally the outgoing light and the environmental light are mixed to form a required illuminating environment.

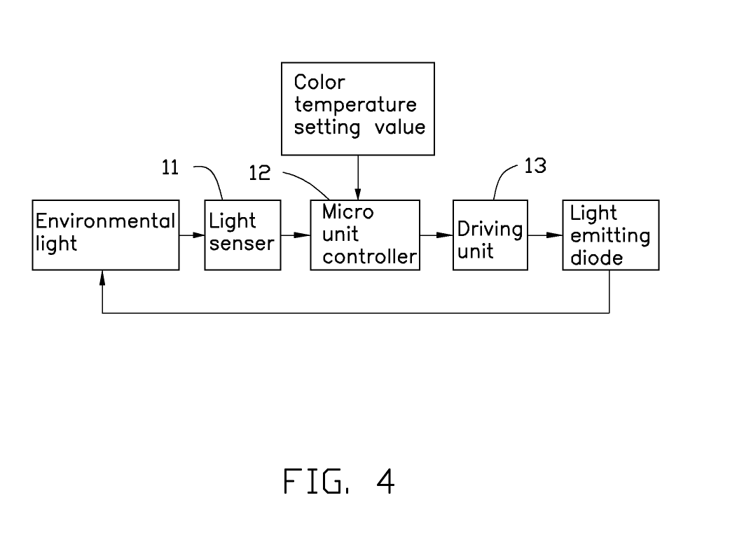

Referring to FIGS. 3 and 4, an illuminating device 200 using the above method is shown. The illuminating device 200 includes a main white light source 20, a plurality of first adjusting light sources 21, a plurality of second adjusting light sources 22 and a plurality of third adjusting light sources 23. In this embodiment, each of the first adjusting light sources 21 is a red light source, each of the second adjusting light sources 22 is a green light source and each of the third adjusting light sources 23 is a blue light source.

In this embodiment, the main white light source 20 includes a first sub-main white light source 201, a second sub-main white light source 202, a third sub-main white light source 203 and a fourth sub-main white light source 204. The main white light source 20 is positioned in a middle of the illuminating device 200, with the four sub-main light sources 201, 202, 203, 204 arranged in a square array. The four sub-main light sources 201, 202, 203 and 204 are arranged in a same plane, whereby light output surfaces of the sub-main light sources 201, 202, 203, 204 cooperatively form a flat surface.

In this embodiment, the illuminating device 200 includes four first adjusting light sources 21, four second adjusting light sources 22 and four third adjusting light sources 23 surrounding the main white light source 20. The first sub-main white light source 201 emits light of 3500K color temperature. The second sub-main white light source 202 emits light of 4500K color temperature. The third sub-main white light source 203 emits light of 5500K color temperature. The fourth sub-main white light source 204 emits light of 15000K color temperature. Alternatively, the color temperatures of the four sub-main white light sources 201, 202, 203 and 204 are not limited as described. The color temperature of the main white light source 20 can be adjusted by changing current applied to each of the four sub-main white light sources 201, 202, 203 and 204.

The main white light source 20 and the four first adjusting light sources 21, four second adjusting light sources 22, four third adjusting light sources 23 are arranged in a same plane and form a square array. The four first adjusting light sources 21, four second adjusting light sources 22, four third adjusting light sources 23 are arranged alternately around the four sub-main white light sources 201, 202, 203, 204 of the main white light source 20, wherein the four first adjusting light sources 21 are located at four corners of the square. Each of the light sources 201, 202, 203, 204, 21, 22, 23 is an LED. Also, the brightness of the adjusting light sources 21, 22 and 23 can be adjusted by changing currents applied thereto. The light produced by the adjusting light sources 21, 22, 23 mix with the light produced by the main light source 20 to obtain the outgoing light, which has a required color temperature and a good color rendering property. In order to get better mixing effect, the first adjusting light sources 21, the second adjusting light sources 22 and the third adjusting light sources 23 are located next to the main light source 20 as close as possible. The outgoing light is white light and has a chromaticity coordinate located at the Plank's curve.

The illuminating device 200 further includes a light sensor 11, a micro unit controller 12 and a driving unit 13. The light sensor 11 senses the environmental light and gets data thereof firstly. The data of the environment light is transferred to the micro unit controller 12. The micro unit controller 12 compares the data of the environment light with the color temperature setting value to calculate a required compensating light value. The driving unit 13 drives the sub-main white light sources 201, 202, 203, 204 and the adjusting light sources 21, 22, 23 to emit required light rays which are mixed together to obtain the outgoing light having the required compensating light value. Finally, the outgoing light and the environmental light are mixed together to obtain a resulted light which has a color temperature equal to the color temperature setting value. The light sensor 11 continuously senses the resulted light, the micro unit controller 12 adaptively adjusts the illuminating device 200 thereby to adjust the outgoing light when the resulted light changes in brightness and chromaticity. Alternatively, the setting value stored in the micro unit controller 12 is manually input by user.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. A color temperature adjusting method comprising steps:
providing a controller storing a color temperature setting value therein, a main white light source comprising a first sub-main white light source and a second sub-main white light source having a color temperature different from that of the first sub-main white light source, and an adjusting light source comprising a red light source, a green light source and a blue light source;
comparing the color temperature setting value with that of a environmental light to obtain a difference value;
controlling brightness of each of the first and second sub-main white light sources, the red light source, the green light source and the blue light source according to the difference value to obtain a compensation light; and
mixing the compensation light with the environmental light to obtain a resulted light which has a color temperature equal to the color temperature setting value stored in the controller.

2. The color temperature adjusting method of claim 1, wherein a light sensor is provided to sense the environmental light and transfer the data of the environmental light to the controller, the controller comparing the data of the environment light with the setting value to calculate the difference value.

3. The color temperature adjusting method of claim 2, wherein the light sensor continuously senses the resulted light after the compensation light and the environmental light are mixed together, the controller adaptively adjusting the illuminating device thereby to adjust the compensation light when the resulted light changes its characteristic.

4. The color temperature adjusting method of claim 1, wherein the brightness of the two sub-main white light sources, the red light source, the green light source and the blue light source are adjusted by adjusting input currents thereof

5. The color temperature adjusting method of claim 4, a third sub-main white light source and a fourth sub-main white light source are further provided to obtain the compensation light, color temperatures of the first sub-main white light source, the second sub-main white light source, the third sub-main white light source and the fourth sub-main white light source being different from each other.

6. The color temperature adjusting method of claim 5, wherein a color temperature of the compensation light is different from that of each of the first sub-main white light source, the second sub-main white light source, the third sub-main white light source and the fourth sub-main white light source, the compensation light having a chromaticity coordinate on the CIE 1931 chromaticity coordinates chart.

7. The color temperature adjusting method of claim 1, wherein the color temperature setting value stored in the controller is manually input by user.

8. The color temperature adjusting method of claim 1, wherein a driving unit is provided to drive the two sub-main white light sources, the red light source, the green light source and the blue light source to obtain the compensation light.

9. An illuminating device, comprising:
a main white light source comprising two sub-main white light sources;
a plurality of red light sources;
a plurality of blue light sources; and
a plurality of green light sources;
wherein the main white light source is set in a middle of the illuminating device, the red, blue and green light sources alternately surrounding the main light source; and
wherein a brightness of each of the red, blue and green light sources is changeable to change a color temperature of light from the main white light source by mixing light of the red, blue, green light sources with the light from the main white light source, the light from the main white light source and the light from the red, blue and green light sources being mixed together to obtain an outgoing light of the illuminating device which has a chromaticity coordinate located at a Plank's curve on a CIE 1931 chromaticity coordinates chart.

10. The illuminating device of claim 9, wherein color temperatures of the two sub-main white light sources are different from each other.

11. The illuminating device of claim 10, wherein a brightness of light obtained by mixing light from the two sub-main white light sources is changeable by changing currents applied to the two sub-main white light sources.

12. The illuminating device of claim 9, the main white light source, the blue light sources, the red light sources and the green light sources are arranged in a same plane.

13. The illuminating device of claim 12, the red light sources, the blue light sources and the green light sources are arranged alternately around the main white light source.
